(19) United States
(12) Patent Application Publication
(10) Pub. No.: US 2025/0372774 A1
(43) Pub. Date: Dec. 4, 2025

(54) CYLINDRICAL SECONDARY BATTERY

(71) Applicant: MURATA MANUFACTURING CO., LTD., Kyoto (JP)

(72) Inventor: Kunio SODEYAMA, Kyoto (JP)

(21) Appl. No.: 19/088,189

(22) Filed: Mar. 24, 2025

(30) Foreign Application Priority Data
Jun. 1, 2024 (JP) 2024-096839

(51) Int. Cl. H01M 50/152; H01M 10/0587; H01M 50/107; H01M 50/159

(52) U.S. Cl. CPC H01M 50/152; H01M 10/0587; H01M 50/107; H01M 50/159; H01M 2220/30

(57) ABSTRACT

A cylindrical secondary battery is provided and including: an electrode wound body having a structure in which a band-shaped positive electrode and a band-shaped negative electrode are stacked and wound with a separator interposed therebetween; a battery can accommodating the electrode wound body with one end portion being open while the electrode wound body is accommodated; and a battery lid provided at the one end portion of the battery can and having two or more opening portions, wherein the two or more opening portions have a non-overlapping form during rotation that does not overlap the two or more opening portions before rotation when the two or more opening portions are rotated by more than 0° and less than 360° about an axis of a cylindrical shape of the secondary battery in top view, and the battery lid has a cleavage impression at any one of joints between two adjacent opening portions out of the two or more opening portions.

### CROSS REFERENCE TO RELATED APPLICATIONS

The present application claims priority to Japanese Patent Application No. 2024-096839, filed on Jun. 1, 2024, the entire contents of which are incorporated herein by reference.

### BACKGROUND

The present disclosure relates to a cylindrical secondary battery.

In recent years, there has been a demand for improvement in performance related to reliability of secondary batteries with a request for a long service life and high output of power tools and electrical appliances. Among the secondary batteries, in particular, a cylindrical secondary battery has a structure including an electrode wound body, a battery can accommodating the electrode wound body with one end portion being open, and a battery lid closing the one end portion of the battery can.

In order to improve the reliability of such a cylindrical secondary battery, there is known a technique in which a battery lid is provided with a plurality of opening portions configured to release gas generated inside the battery to the outside of the battery at the time of battery abnormality.

### SUMMARY

The present disclosure relates to a cylindrical secondary battery.

In the related art, for example, as illustrated in FIG. 11, a plurality of opening portions 900a to 900d provided in a battery lid have the same dimensions and the same shape as each other in top view, and are arranged at equal intervals in the circumferential direction with an axis of a cylindrical shape of a secondary battery as a center C. Moreover, each of the plurality of opening portions 900a to 900d has a shape having line symmetry with respect to any one straight line passing through the center with the axis of the cylindrical shape as the center C in top view. Therefore, when gas is generated inside the battery and the gas is ejected to the outside, the gas is ejected uniformly from each of these opening portions, so that the battery may pop out like a projectile, which has caused a new problem regarding safety. Specifically, for example, as illustrated in FIG. 12, due to the presence of flame outside the battery or the like, gas was generated inside the battery to increase the internal pressure at the time of battery abnormality such as occurrence of an ignition starting point H inside the battery. When the gas is ejected to the outside due to such an increase in the internal pressure, as illustrated in FIG. 13, the gas is ejected uniformly from each of these opening portions 900a to 900d, so that the battery may pop out like a projectile, and as a result, a decrease in a pass rate of a combustion test has become a new problem. FIG. 11 is a schematic top view illustrating an example of the battery lid in the secondary battery according to the related art. FIG. 12 is a schematic sectional view of the secondary battery illustrating a gas flow generated inside the secondary battery at the time of battery abnormality. In FIG. 12, an arrow indicates a direction of the gas flow. FIG. 13 is a schematic top view of the battery lid for describing a mechanism in which the battery flies out like a projectile due to ejection of gas generated inside the secondary battery at the time of battery abnormality.

However, due to the presence of such opening portions in the battery lid, there is a concern that the strength of the battery itself is insufficient, and a decrease in a pass rate of a drop test has also become a new problem.

The present disclosure, in an embodiment, relates to providing a cylindrical secondary battery capable of sufficiently preventing pop-out of the battery due to ejection of gas generated inside the battery at the time of battery abnormality, and thus is excellent in safety.

In an embodiment of the present disclosure, a cylindrical secondary battery is provided that is capable of more sufficiently preventing pop-out of the battery like a projectile due to ejection of gas generated inside the battery at the time of battery abnormality and has more sufficient strength while, and thus is excellent in safety and strength characteristic.

The present disclosure relates to a cylindrical secondary battery, in an embodiment, including:
an electrode wound body having a structure in which a band-shaped positive electrode and a band-shaped negative electrode are stacked and wound with a separator interposed therebetween;
a battery can accommodating the electrode wound body with one end portion being open while the electrode wound body is accommodated; and
a battery lid provided at the one end portion of the battery can and having two or more opening portions,
wherein the two or more opening portions have a non-overlapping form during rotation that does not overlap the two or more opening portions before rotation when the two or more opening portions are rotated by more than 0° and less than 360° about an axis of a cylindrical shape of the secondary battery in top view, and
the battery lid has a cleavage impression at any one of joints between two adjacent opening portions out of the two or more opening portions.

The cylindrical secondary battery according to the present disclosure, in an embodiment, is capable of more sufficiently preventing the pop-out of the battery like the projectile due to the ejection of the gas generated inside the battery at the time of battery abnormality, and thus is excellent in the safety since.

### BRIEF DESCRIPTION OF THE FIGURES

FIG. 1 is a schematic sectional view illustrating an embodiment of a secondary battery according to the present disclosure;

FIG. 2 is a schematic top view (left side) illustrating an embodiment of a battery lid in the secondary battery according to the present disclosure and a schematic sectional view taken along line A-A′ thereof;

FIG. 3 is a schematic top view (left side) illustrating an embodiment of the battery lid in the secondary battery according to the present disclosure and a schematic sectional view taken along line B-B′ thereof;

FIG. 4 is a schematic top view illustrating an embodiment of the battery lid in the secondary battery according to the present disclosure;

FIG. 5 is a schematic top view illustrating an embodiment of the battery lid in the secondary battery according to the present disclosure;

FIG. 6 is a schematic top view of the battery lid for describing a mechanism in which the secondary battery according to the present disclosure prevents pop-out like a projectile at the time of battery abnormality;

FIG. 7 is a connection diagram used for describing a battery pack as an application example of the present disclosure;

FIG. 8 is a connection diagram used for describing a power tool as an application example of the present disclosure;

FIG. 9 is a connection diagram used for describing an electric vehicle as an application example of the present disclosure;

FIG. 10 is a schematic top view illustrating an example of a battery lid in a secondary battery according to a comparative example;

FIG. 11 is a schematic top view illustrating an example of a battery lid in a secondary battery according to the related art (or a comparative example);

FIG. 12 is a schematic sectional view of the secondary battery illustrating a gas flow generated inside the secondary battery at the time of battery abnormality; and

FIG. 13 is a schematic top view of the battery lid for describing a mechanism in which the battery flies out like a projectile due to ejection of gas generated inside the secondary battery at the time of battery abnormality.

### DETAILED DESCRIPTION

A cylindrical secondary battery (hereinafter, may be simply referred to as the “secondary battery”) according to the present disclosure of an embodiment will be described in further detail below. Although the description will be made with reference to the drawings as necessary, various elements in the drawings are only schematically and exemplarily illustrated for understanding of the present disclosure, and the appearances, the dimensional ratios, and the like may be different from actual ones unless otherwise specified.

A “sectional view” described directly or indirectly in the present specification is based on a virtual section (or sectional view) obtained by cutting the secondary battery in a direction along a rotation axis direction (that is, a winding axis direction) of an electrode wound body constituting the secondary battery. A “top view” used in the present specification is based on a sketch drawing (or a plan view) when an object is viewed from above along the rotation axis direction.

In addition, an “up-down direction” and a “left-right direction” used directly or indirectly in the present specification correspond to an up-down direction and a left-right direction in the drawings, respectively. Unless otherwise specified, the same reference signs or symbols denote the same members and/or sites, or the same semantic contents. In a preferred aspect, it can be understood that a downward direction in a vertical direction (that is, a direction in which gravity acts) is equivalent to a “downward direction”, and an opposite direction is equivalent to an “upward direction”. In the present specification, a term (for example, “parallel”, “orthogonal”, “vertical”, “matching”, “fully overlapping”, or the like) indicating a relationship between elements and a term indicating a shape of an element not only mean only strictly literal aspects, but also mean substantially equivalent ranges, for example, ranges including a difference of about several %.

In the present description, the “secondary battery” refers to a battery that can be repeatedly charged and discharged. Thus, the secondary battery according to an embodiment of the present disclosure is not excessively limited by its name, and for example, an electrochemical device such as a power storage device may also be included in the secondary battery. Hereinafter, a case where the secondary battery of the present disclosure is a lithium ion battery charged and discharged by movement of lithium ions between a positive electrode and a negative electrode will be described in detail, but mediator ions are not particularly limited as long as charge and discharge can be performed, and may be, for example, sodium ions or magnesium ions.

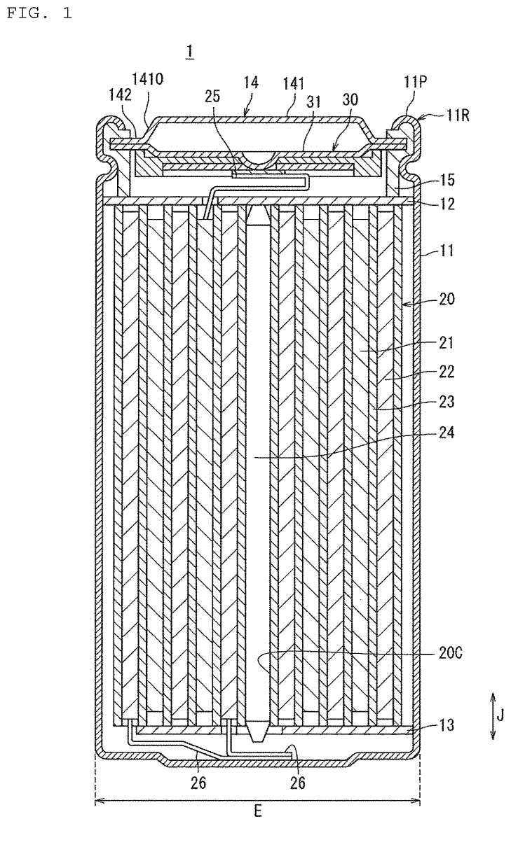

The secondary battery of the present disclosure has, for example, a cylindrical structure as illustrated in FIG. 1. A secondary battery 1 of the present disclosure includes an electrode wound body 20 having a structure in which a band-shaped positive electrode 21 and a band-shaped negative electrode 22 are stacked and wound with a separator 23 interposed therebetween, a battery can 11 accommodating the electrode wound body 20 with one end portion being open, and a battery lid 14 provided at the one end portion of the battery can 11, and usually further includes insulators 12 and 13, a gasket 15, a positive electrode lead 25, a negative electrode lead 26, a safety valve mechanism 30, and an electrolytic solution (not illustrated). An axis of a cylindrical shape of the secondary battery may match a winding axis or a rotation axis of the electrode wound body 20, and may be simply referred to as the “axis” in the present specification. FIG. 1 is a schematic sectional view illustrating an embodiment of the cylindrical secondary battery according to the present disclosure.

The battery can 11 is a member that mainly houses the electrode wound body 20. The battery can 11 is, for example, a cylindrical container in which one end portion is open and the other end portion is closed. That is, the battery can 11 has an open end portion. The battery can 11 contains any one kind, or two or more kinds of metal materials such as iron, stainless steel, aluminum, and alloys thereof. The surface of the battery can 11 may be, however, plated with any one kind, or two or more kinds of metal materials such as nickel.

A crimp structure 11R is formed at the open end portion of the battery can 11, in which a battery lid 14 and a safety valve mechanism 30 to be described later are crimped with a gasket 15 interposed therebetween. As a result, the battery can 11 is hermetically sealed in a state where the electrode wound body 20 and the like are housed inside the battery can 11.

The insulators 12 and 13 are sheet-like members each having a face substantially perpendicular to the winding axis direction (vertical direction of FIG. 1) of the electrode wound body 20. The insulators 12 and 13 are arranged in such a manner as to sandwich the electrode wound body 20 therebetween. As a material of the insulators 12 and 13, polyethylene terephthalate (PET), polypropylene (PP), bakelite, or the like is used. Examples of bakelite include paper bakelite and cloth bakelite produced by applying a phenolic resin to paper or cloth and then heating the paper or cloth.

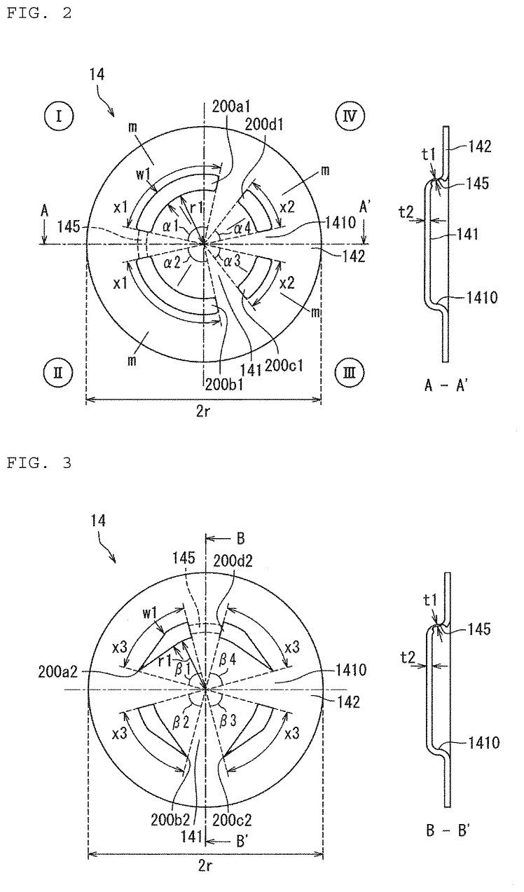

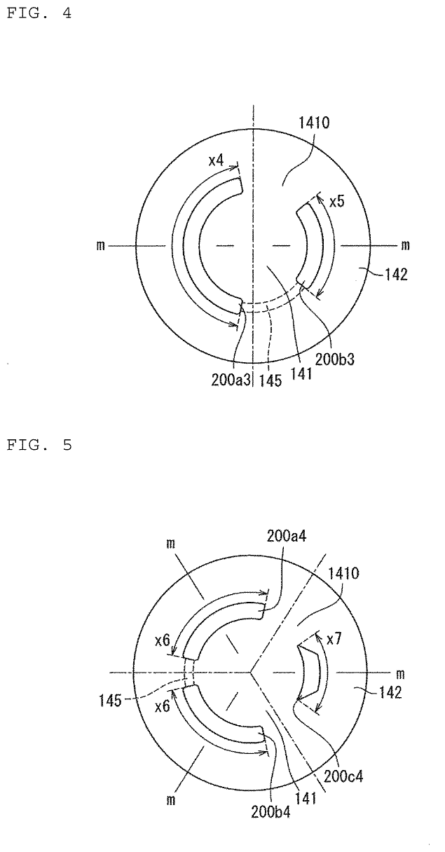

The battery lid 14 is a member that closes the open end portion of the battery can 11 in a state where the electrode wound body 20 and the like are housed inside the battery can 11, and has two or more opening portions 200 (200a1 to 200d1, 200a2 to 200d2, 200a3 to 200b3, and 200a4 to 200c4) as illustrated in FIGS. 2 to 5. Since the battery lid 14 has the opening portions 200, the open end portion of the battery can 11 is not strictly closed. However, the battery lid 14 has a structure and an installation form that contribute to sealing of the battery can 11 as if the battery lid 14 has no opening portion. Each of FIGS. 2 to 5 is a schematic top view illustrating an embodiment of the battery lid in the secondary battery according to the present disclosure. In particular, FIGS. 2 and 3 illustrate schematic sectional views, taken along line A-A′ and line B-B′ in the schematic top views illustrated on the left side, respectively, on the right side.

The battery lid 14 may have a hat shape, and in the case of having the hat shape, includes a protruding portion 141 in which a central region of the battery lid 14 protrudes toward a counter electrode wound body side in an axial direction J of the cylindrical shape of the secondary battery, and an annular flange-shaped portion 142 arranged around the protruding portion 141 as illustrated in FIG. 1. The counter electrode wound body side in the axial direction J means a side (upper side in FIG. 1) opposite to a side where the electrode wound body 20 is present with the battery lid 14 as a reference in the axial direction J of the cylindrical shape of the secondary battery. In this case, the battery lid 14 usually has two or more opening portions 200 on a side surface 1410 of the protruding portion 141. At this time, the battery lid 14 has all of the two or more opening portions 200 of the battery lid 14 on the side surface 1410. The protruding portion 141 usually has a substantially circular shape in top view.

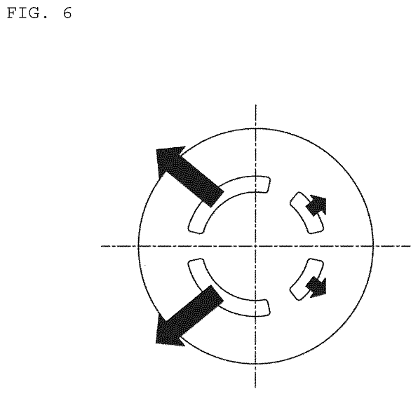

The two or more opening portions 200 (specifically, all of the opening portions 200) of the battery lid 14 usually have a rotation-direction extending shape extending in a rotation direction about the axis of the cylindrical shape of the secondary battery (for example, the winding axis or the rotation axis of the electrode wound body 20). The rotation-direction extending shape means a shape formed to extend in the rotation direction. The rotation-direction extending shape may be, for example, an outer curved quadrangular shape formed so as curve outward as in the opening portions 200a1 to 200d1 in FIG. 2, the opening portions 200a3 and 200b3 in FIG. 4, and the opening portions 200a4 to 200b4 in FIG. 5, may be a one-end tapered shape (or one-end taper shape) formed so as to curve outward with one end (or only one end) being tapered as in the opening portions 200a2 to 200d2 in FIG. 3, or may be a both-end tapered shape (or both-end taper shape) formed so as to curve outward with both ends being tapered as in the opening portion 200c4 in FIG. 5. As the shapes of the opening portions 200, the outer curved quadrangular shape or the one-end tapered shape is preferably provided, and the outer curved quadrangular shape is more preferably provided, from the viewpoint of further improving safety and improving battery strength. The two or more opening portions 200 may have shapes different from each other, but preferably have the same shape from the viewpoint of further improving the safety and improving the battery strength. When the two or more opening portions extend in the radial direction about the axis of the cylindrical shape of the secondary battery, an ejection pressure of a gas fluid increases toward the center, so that pop-out of the battery like a projectile cannot be sufficiently prevented.

In the present specification, safety is a characteristic that the pop-out of the battery like the projectile is sufficiently prevented. It is more excellent in safety as a pass rate in the combustion test (UL 1642 projectile test) increases. The strength characteristic is a characteristic that the strength of the battery is sufficiently high, and is a characteristic that leakage of the electrolytic solution is more sufficiently prevented when the battery is dropped from a height of 10 mm. The strength characteristic is more excellent as a pass rate in the drop test is higher. The strength characteristic is not necessarily a characteristic that the secondary battery of the present disclosure should have, and is a characteristic that the secondary battery of the present disclosure preferably has.

As illustrated in FIGS. 2 to 5, it is preferable that the two or more opening portions 200 (specifically, all of the opening portions 200) of the battery lid 14 are usually arranged in a concentric region about the axis. The arrangement of the two or more opening portions 200 in the concentric region means that all of the two or more opening portions 200 are arranged in a region between two concentric circles having diameters different from each other and centered on the axis. In particular, when the battery lid 14 has the protruding portion 141 and the flange-shaped portion 142 and has two or more opening portions 200 on the side surface 1410 of the protruding portion 141, the two or more opening portions 200 are usually arranged in the concentric region about the axis.

As illustrated in FIGS. 2 to 5, the two or more opening portions 200 (specifically, all of the opening portions 200) of the battery lid 14 are usually arranged in a line along the rotation direction about the axis. Thus, as illustrated in FIGS. 2 to 5, the two or more opening portions 200 (specifically, all of the opening portions 200) of the battery lid 14 are generally arranged in one annular shape about the axis.

The two or more opening portions 200 (specifically, all of the opening portions 200) of the battery lid 14 have a non-overlapping form during rotation no to overlap the two or more opening portions before rotation when being rotated by more than 0° and less than 360° about the axis of the cylindrical shape of the secondary battery in top view. In the non-overlapping form during rotation, specifically, when all of the two or more opening portions 200 are rotated about the axis by more than 0° and less than 360°, the two or more opening portions after the rotation do not fully overlap the two or more opening portions before the rotation. More specifically, as illustrated in each of FIGS. 2 to 5, when all of the two or more opening portions are gradually rotated counterclockwise about the axis at an angle of more than 0° and less than 360°, there is no rotation angle at which all of the two or more opening portions after the rotation fully overlap all of the two or more opening portions before the rotation. The expression “fully overlapping” means that, when all of the two or more opening portions are overlapped before and after rotation and viewed virtually, each of the two or more opening portions after the rotation matches any of the two or more opening portions before the rotation from the viewpoint of the dimension, shape, and arrangement of each of the opening portions.

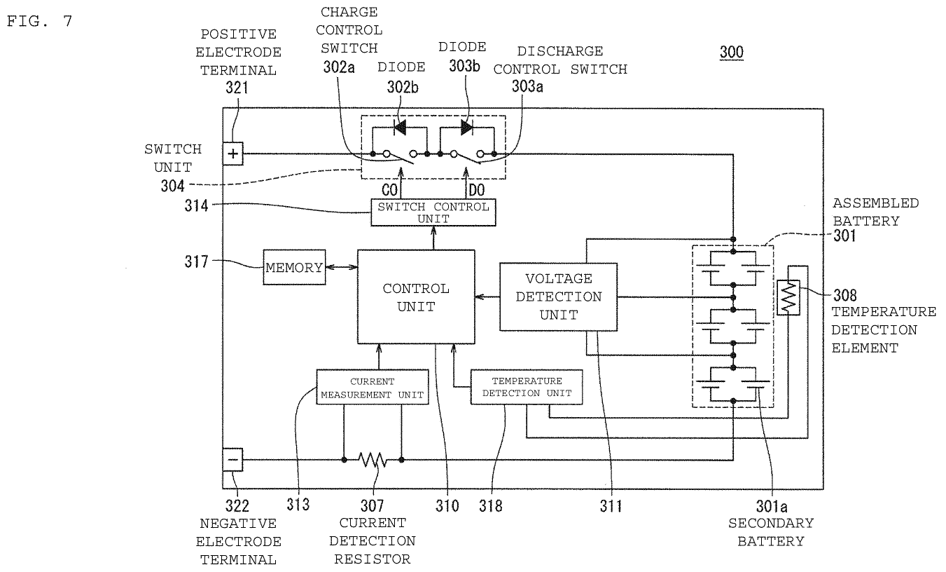

Since the two or more opening portions 200 (specifically, all of the opening portions 200) of the battery lid 14 have the non-overlapping form during rotation, although gas generated inside the battery is ejected to the outside, the gas is ejected non-uniformly from each of the opening portions as illustrated in FIG. 6, so that the pop-out of the battery like the projectile can be more sufficiently prevented. For example, the secondary battery of the present disclosure rotates with the axial direction as a diameter on the basis of the non-uniform ejection although the gas is ejected to the outside, and thus can more sufficiently prevent the pop-out of the battery like the projectile. In a case where the two or more opening portions included in the battery lid do not have the non-overlapping form during rotation, when gas generated inside the battery is ejected to the outside, the gas is ejected uniformly from each of the opening portions, so that the battery pops out like the projectile. FIG. 6 is a schematic top view of the battery lid for describing a mechanism in which the secondary battery according to the present disclosure prevents the pop-out like the projectile at the time of battery abnormality.

The non-overlapping form during rotation of the two or more opening portions 200 (specifically, all of the opening portions 200) in the battery lid 14 may be based on non-equal division and/or asymmetric shapes of the opening portions.

The non-overlapping form during rotation based on the non-equal division of the opening portion means that the non-overlapping form during rotation is achieved based on a difference in opening portion dimension (particularly, a difference in opening portion dimension between two opening portions to be overlapped/non-overlapped (opening portions before and after rotation)) as illustrated in FIG. 2. In this case, the opening portions 200 may include two or more kinds (particularly, two kinds) of opening portions having opening portion dimensions different from each other. An opening portion dimension is the maximum length of an opening portion in the rotation direction, and specifically, the maximum length of the opening portion in the rotation direction (circumferential direction) about the axis. When the opening portions 200 include two kinds of opening portions having opening portion dimensions different from each other and the opening portion dimensions of the two kinds of opening portions are p and q (where p<q), p and q may satisfy the relational expression: 1.5×p≤q≤4×p (particularly 2×p≤q≤3×p).

The battery lid 14 of FIG. 2 has two kinds of opening portions having opening portion dimensions different from each other (the opening portions 200a1 and 200b1 each having an opening portion dimension x1 and the opening portions 200c1 and 200d1 each having an opening portion dimension x2). Therefore, the opening portions 200a1 to 200d1 of the battery lid 14 of FIG. 2 have a non-overlapping form during rotation based on non-equal division of the opening portions. The battery lid 14 of FIG. 4 has two kinds of opening portions having opening portion dimensions different from each other (the opening portion 200a3 having an opening portion dimension x4 and the opening portion 200b3 having an opening portion dimension x5). Therefore, the opening portions 200a3 and 200b3 of the battery lid 14 of FIG. 4 have a non-overlapping form during rotation based on non-equal division of the opening portions. On the other hand, the battery lid 14 of FIG. 3 has only opening portions having the same opening portion dimension (the opening portions 200a2 to 200d2 each having an opening portion dimension x3). Therefore, the opening portions 200a2 to 200d2 of the battery lid 14 of FIG. 3 do not have a non-overlapping form during rotation based on non-equal division, but has a non-overlapping form during rotation based on asymmetric shapes of the opening portions as described later.

The non-overlapping form during rotation based on the asymmetric shapes of the opening portions means that the non-overlapping form during rotation is achieved based on a difference in opening portion shape (particularly, a difference in opening portion shape between two opening portions to be overlapped/non-overlapped (opening portions before and after rotation) as illustrated in FIG. 3. The difference in opening portion shape may be based on the presence or absence of asymmetry of the opening portion shape. In this case, the opening portions 200 may include two kinds of opening portions having opening portion shapes different from each other (for example, the opening portions 200a2 and 200b2 each having a one-end tapered shape tapered in the counterclockwise direction and the opening portions 200c2 and 200d2 each having a one-end tapered shape tapered in the clockwise direction). The asymmetry of the opening portion shape means that there is no line symmetry with the axis as a center with respect to any straight line passing through the center. For example, each of the opening portions 200a2 to 200d2 in FIG. 3 has no line symmetry with the axis as a center with respect to any straight line passing through the center, and thus has asymmetry. On the other hand, for example, each of the opening portions 200a1 to 200d1 in FIG. 2, the opening portions 200a3 and 200b3 in FIG. 4, and the opening portions 200a4 to 200c4 in FIG. 5 has line symmetry with the axis as a center with respect to a straight line m passing through the center, and thus does not have asymmetry.

The battery lid 14 of FIG. 3 has two kinds of opening portions having opening portion shapes different from each other (the opening portions 200a2 and 200b2 each having the one-end tapered shape tapered in the counterclockwise direction and the opening portions 200c2 and 200d2 each having the one-end tapered shape tapered in the clockwise direction). Therefore, the opening portions 200a2 to 200d2 of the battery lid 14 of FIG. 3 have the non-overlapping form during rotation based on the asymmetric shapes of the opening portions. The battery lid 14 of FIG. 4 has two kinds of opening portions having opening portion dimensions different from each other (the opening portion 200a3 having an opening portion dimension x4 and the opening portion 200b3 having an opening portion dimension x5). Therefore, the opening portions 200a3 and 200b3 of the battery lid 14 of FIG. 4 have a non-overlapping form during rotation based on non-equal division of the opening portions.

The arrangement of the two or more opening portions 200 of the battery lid 14 is not particularly limited as long as the two or more opening portions 200 (specifically, all of the opening portions 200) have a non-overlapping form during rotation. For example, in a case where the battery lid 14 has n opening portions, the n opening portions may be arranged one by one in each of regions delimited by a central angle represented by 360°/n about the axis. The region delimited by the central angle represented by 360°/n is indicated by an alternate long and short dash line in FIGS. 2 to 5. For example, in a case where the battery lid 14 has four opening portions, the four opening portions may be arranged one by one in each of regions delimited by a central angle of 90° (=360°/4) about the axis as illustrated in FIGS. 2 and 3. Further, for example, in a case where the battery lid 14 has two opening portions, the two opening portions may be arranged one by one in each of regions delimited by a central angle of 180° (=360°/2) about the axis as illustrated in FIG. 4. For example, in a case where the battery lid 14 has three opening portions, the three opening portions may be arranged one by one in each of regions delimited by a central angle of 120° (=360°/3) about the axis as illustrated in FIG. 5.

One opening portion does not necessarily have to be strictly arranged within a range of one region delimited by a central angle expressed by 360°/n, and may be arranged across two adjacent regions. For example, as long as an opening area of more than 50% (particularly 70% or more) of one opening portion is arranged in a predetermined region, the one opening portion may be arranged across two regions among regions delimited by a central angle represented by 360°/n.

Specifically, for example, as illustrated in FIG. 2, one opening portion 200a1 arranged in a region I may be arranged in an adjacent region IV as long as more than 50% of the opening area thereof is arranged in the region I.

An opening ratio of opening portions of the battery lid 14 is usually 5.0% or more and 12.0% or less, and from the viewpoint of further improving the safety and improving the battery strength, is preferably 7.0% or more and 12.0% or less, more preferably 8.0% or more and 10.0% or less, and still more preferably 8.5% or more and 9.5% or less.

The opening ratio of the opening portions is a total opening ratio of two or more opening portions of the battery lid 14 in plan view, and is a ratio to a battery radial area. The battery radial area means the area of the battery in plan view, and a top view area E (see FIG. 1) of the battery can 11 is used.

Distances (particularly, the shortest distances) r1 (see FIGS. 2 and 3) of opening portions of the battery lid 14 from the axis (center) are usually 0.3×r (mm) or more and 0.8×r (mm) or less independently of each other, and from the viewpoint of further improving the safety and improving the battery strength, are preferably 0.4×r (mm) or more and 0.7×r (mm) or less, and more preferably 0.4×r (mm) or more and 0.6×r (mm) or less, where r (mm) is a radius of the battery lid 14.

Widths (particularly, the maximum widths) w1 (see FIGS. 2 and 3) in the radial direction about the axis (center) of opening portions of the battery lid 14 are usually 0.1×r (mm) or more and 0.5×r (mm) or less independently of each other, and from the viewpoint of further improving the safety and improving the battery strength, are preferably 0.1×r (mm) or more and 0.3×r (mm) or less, and more preferably 0.1×r (mm) or more and 0.2×r (mm) or less, where r (mm) represents the radius of the battery lid 14.

The radius r of the battery lid 14 is not particularly limited, and may be, for example, 7 mm or more and 11 mm or less. A value corresponding to twice the radius r of the battery lid 14 may correspond to an outer diameter of the secondary battery of the present disclosure (a diameter of the battery can 11).

The opening portion dimensions x (for example, x1 and x2 in FIG. 2, x3 in FIGS. 3, x4 and x5 in FIGS. 4, x6 and x7 in FIG. 5, and the like) of opening portions of the battery lid 14 are usually 10° or more and 160° or less at opening angles (for example, x1 to x4 in FIGS. 2 and 31 to 34 in FIG. 3) about the axis independently of each other, and from the viewpoint of further improving safety and improving battery strength, are preferably 20° or more and 100° or less, and more preferably 30° or more and 95° or less. The opening angle about the axis is based on the opening portion dimension x of the opening portion of the battery lid 14.

The battery lid 14 has a cleavage impression 145 at any one of joints of two adjacent opening portions out of the two or more opening portions 200. Since the battery lid 14 has the cleavage impression, the safety of the secondary battery is significantly improved. In a case where the battery lid 14 has no cleavage impression, the safety is deteriorated. A joint is a battery lid material between the two adjacent opening portions. In particular, when the battery lid 14 has the protruding portion 141 and the flange-shaped portion 142 described above, a joint is a side surface material between two adjacent opening portions in the side surface 1410 of the protruding portion 141. The cleavage impression 145 is usually formed over the entire width of the joint.

The cleavage impression 145 promotes cleavage of the battery (particularly, the battery lid) when gas generated inside the battery is ejected to the outside, and is a portion formed to be thinner than a thickness of the other portion of the battery lid. A thickness t1 (mm) of the cleavage impression 145 is usually 0.1×t2 (mm) or more and 0.8×t2 (mm) or less, where the thickness of the other portion (for example, the protruding portion 141) of the battery lid 14 is t2 (mm), and is preferably 0.1×t2 (mm) or more and 0.6×t2 (mm) or less, more preferably 0.1×t2 (mm) or more and 0.4×t2 (mm) or less from the viewpoint of further improving the safety and improving the battery strength.

The thickness t2 of the other portion (for example, the protruding portion 141 and the flange-shaped portion 142) of the battery lid 14 is not particularly limited, and may be, for example, 0.3 mm or more and 0.7 mm or less, and particularly 0.4 mm or more and 0.6 mm or less.

The joint where the cleavage impression 145 is arranged is usually a joint where a load (or stress) caused by ejection at the time of the ejection of gas is maximized. For example, the cleavage impression is placed at a joint that is likely to be cleaved since the load (or stress) caused by ejection is the maximum if gas is ejected from the inside of the secondary battery.

When all of joint dimensions are equal as illustrated in FIG. 2, the joint where the load caused by the ejection is maximized may be a joint between two opening portions each having the largest opening area among the two or more opening portions of the battery lid 14, and may be a joint between one opening portion having the largest opening area and one opening portion having the second largest opening area. A joint dimension is an overall width dimension (particularly, the shortest distance between two adjacent opening portions) of a joint.

When all of joint dimensions are equal, the opening areas of all of the opening portions are equal, and the opening portions include the opening portions 200a2 and 200b2 each having the one-end tapered shape tapered in the counterclockwise direction and the opening portions 200c2 and 200d2 each having the one-end tapered shape tapered in the clockwise direction as illustrated in FIG. 3, the joint where the load caused by the ejection is maximized is a joint between an opening portion having a one-end tapered shape tapered in the counterclockwise direction and an opening portion having a one-end tapered shape tapered in the clockwise direction, and is a joint between the other end portions not having a tapered shape of the one-end tapered shapes.

The battery lid 14 contains any one kind, or two or more kinds of metal materials such as iron, stainless steel, aluminum, and alloys thereof. The surface of the battery lid 14 may be plated with any one kind, or two or more kinds of metal materials such as nickel.

The gasket 15 is a member mainly interposed between a bent portion 11P (also referred to as a crimped portion) of the battery can 11, and the battery lid 14 and the safety valve mechanism 30 to seal a gap between the bent portion 11P, and the battery lid 14 and the safety valve mechanism 30. The surface of the gasket 15 may be coated with asphalt or the like, for example.

The gasket 15 contains an insulating material. The kind of the insulating material is not particularly limited and is a polymer material such as polybutylene terephthalate (PBT) or polypropylene (PP). This is because the gap between the bent portion 11P, and the battery lid 14 and the safety valve mechanism 30 is sufficiently sealed while the battery can 11 and the battery lid 14 are electrically separated from each other.

The safety valve mechanism 30 substantially ensures the sealed state of the battery can 11 and releases the sealed state of the battery can 11 to release the pressure (internal pressure) inside the battery can 11, if necessary, when the internal pressure increases. The cause of the increase in the internal pressure of the battery can 11 is gas generated due to a decomposition reaction of the electrolytic solution during charge and discharge.

In the safety valve mechanism 30, a safety cover 31 is a substantially circular plate-like member and is also called a valve body. The safety cover 31 is made of, for example, aluminum. A central portion of the safety cover 31 may have a protrusion protruding toward the electrode wound body 20 as illustrated in FIG. 1. An outer peripheral portion of the safety cover 31 is joined to an outer peripheral portion of the battery lid 14 by welding. A welding method is not particularly limited, and may be, for example, an ultrasonic welding method. A part of a region 32 where the safety cover 31 and the battery lid 14 are joined is covered with the gasket 15 (FIG. 1) and fixed by the battery can 11.

In the cylindrical lithium ion battery, the band-shaped positive electrode 21 and the band-shaped negative electrode 22 are spirally wound with the separator 23 interposed therebetween, and are housed in the battery can 11 in a state of being impregnated with the electrolytic solution.

Although not illustrated, the positive electrode 21 and the negative electrode 22 are obtained by respectively forming a positive electrode active material layer and a negative electrode active material layer on one side or both sides of a positive electrode current collector and a negative electrode current collector. The material of the positive electrode current collector is a metal foil containing aluminum or an aluminum alloy. The material of the negative electrode current collector is a metal foil containing nickel, a nickel alloy, copper, or a copper alloy. The separator 23 is a porous and insulating film, and enables movement of lithium ions while electrically insulating the positive electrode 21 and the negative electrode 22.

At the center of the electrode wound body 20, a space (central space 20C) generated when the positive electrode 21, the negative electrode 22, and the separator 23 are wound is provided, and a center pin 24 is inserted into the central space 20C (FIG. 1). However, the center pin 24 may be omitted.

A positive electrode lead 25 is connected to the positive electrode 21, and a negative electrode lead 26 is connected to the negative electrode 22 (FIG. 1). The positive electrode lead 25 contains a conductive material such as aluminum. The positive electrode lead 25 is electrically connected to the battery lid 14 with the safety valve mechanism 30 interposed therebetween. The negative electrode lead 26 contains a conductive material such as nickel. The negative electrode lead 26 is electrically connected to the battery can 11. Detailed configurations and materials of the positive electrode 21, the negative electrode 22, the separator 23, and the electrolytic solution will be described later.

The positive electrode active material layer contains at least a positive electrode material (positive electrode active material) capable of occluding and releasing lithium, and may further contain a positive electrode binder, a positive electrode conductive agent, and the like. The positive electrode material is preferably a lithium-containing composite oxide or a lithium-containing phosphate compound. The lithium-containing composite oxide has, for example, a layered rock-salt type or spinel type crystal structure. The lithium-containing phosphate compound has, for example, an olivine type crystal structure.

The positive electrode binder contains a synthetic rubber or a polymer compound. Examples of the synthetic rubber include a styrene-butadiene-based rubber, a fluorine-based rubber, and ethylene propylene diene. Examples of the polymer compound include polyvinylidene fluoride (PVdF) and polyimide.

The positive electrode conductive agent is a carbon material such as graphite, carbon black, acetylene black, or Ketjen black. However, the positive electrode conductive agent may be a metal material and a conductive polymer.

The surface of the negative electrode current collector is preferably roughened for improving the adhesion to the negative electrode active material layer. The negative electrode active material layer contains at least a negative electrode material (negative electrode active material) capable of occluding and releasing lithium, and may further contain a negative electrode binder, a negative electrode conductive agent, and the like.

The negative electrode material contains, for example, a carbon material. The carbon material is easily graphitizable carbon, non-graphitizable carbon, graphite, low crystalline carbon, or amorphous carbon. The shape of the carbon material is fibrous, spherical, granular, or scaly.

The negative electrode material contains, for example, a metal-based material. Examples of the metal-based material include Li (lithium), Si (silicon), Sn (tin), Al (aluminum), Zr (zinc), and Ti (titanium). The metal-based element forms a compound, a mixture, or an alloy with another element, and examples thereof include a silicon oxide (SiOx (0<x≤2)), a silicon carbide (Sic) or an alloy of carbon and silicon, and a lithium titanate (LTO).

In the lithium ion battery 1, when an open-circuit voltage (that is, battery voltage) in a fully charged state is 4.25 V or higher, the release amount of lithium per unit mass increases also with the use of the same positive electrode active material as compared with a case where the open-circuit voltage in the fully charged state is lower. As a result, a high energy density can be obtained.

The separator 23 is a porous film containing a resin, and may be a laminated film of two or more kinds of porous films. Examples of the resin include polypropylene and polyethylene. The separator 23 may include a resin layer on one side or both sides of the porous film as a substrate layer. This is because the adhesion of the separator 23 to each of the positive electrode 21 and the negative electrode 22 is improved, thus keeping the electrode wound body 20 from warping.

The resin layer contains a resin such as PVdF. In the case of forming the resin layer, the substrate layer is coated with a solution prepared by dissolving the resin in an organic solvent, and thereafter, the substrate layer is dried. Alternatively, the substrate layer may be immersed in the solution, and thereafter the substrate layer may be dried. The resin layer preferably contains an inorganic particle or an organic particle in terms of enhancing heat resistance and safety of the battery. Examples of the kind of the inorganic particle include aluminum oxide, aluminum nitride, aluminum hydroxide, magnesium hydroxide, boehmite, talc, silica, and mica. In place of the resin layer, a surface layer formed by a sputtering method, an atomic layer deposition (ALD) method, or the like and containing inorganic particles as a main component may be used.

The electrolytic solution includes a solvent and an electrolyte salt, and may further include an additive and the like, as necessary. The solvent is a nonaqueous solvent such as an organic solvent or water. An electrolytic solution containing a nonaqueous solvent is referred to as a nonaqueous electrolytic solution. Examples of the nonaqueous solvent include a cyclic carbonate ester, a chain carbonate ester, a lactone, a chain carboxylate ester, and a nitrile (mononitrile).

Although a representative example of the electrolyte salt is a lithium salt, a salt other than the lithium salt may be contained. Examples of the lithium salt include lithium hexafluorophosphate (LiPF₆), lithium tetrafluoroborate (LiBF₄), lithium perchlorate (LiClO₄), lithium methanesulfonate (LiCH₃SO₃), lithium trifluoromethanesulfonate (LiCF₃SO₃), and dilithium hexafluorosilicate (Li₂SF₆). These salts may be used in mixture, and among them, it is preferable to use LiPF₆ and LiBF₄ in mixture from the viewpoint of improving battery characteristics. The content of the electrolyte salt is not particularly limited, and is preferably from 0.3 mol/kg to 3 mol/kg with respect to the solvent.

Subsequently, a method of manufacturing the secondary battery will be described. First, in the case of producing the positive electrode 21, the positive electrode active material, the positive electrode binder, and the positive electrode conductive agent are mixed to produce a positive electrode mixture. Subsequently, the positive electrode mixture is dispersed in an organic solvent to produce a positive electrode mixture slurry in a paste form. Subsequently, the positive electrode mixture slurry is applied to both sides of the positive electrode current collector and thereafter dried to form the positive electrode active material layer.

Subsequently, the positive electrode active material layer is compression-molded while being heated using a roll press machine to obtain the positive electrode 21.

The negative electrode 22 is produced in the same procedure as the positive electrode 21 described above.

Next, the positive electrode lead 25 and the negative electrode lead 26 are connected to the positive electrode current collector and the negative electrode current collector, respectively, using a welding method. Subsequently, the positive electrode 21 and the negative electrode 22 are stacked with the separator 23 interposed therebetween, and they are wound to form the electrode wound body 20. Subsequently, the center pin 24 is inserted into the central space 20C of the electrode wound body 20.

Subsequently, the electrode wound body 20 is housed inside the battery can 11 while the electrode wound body 20 is sandwiched between a pair of insulators. Next, one end of the positive electrode lead 25 is connected to the safety valve mechanism 30 and one end of the negative electrode lead 26 is connected to the battery can 11 using a welding method.

Subsequently, the battery can 11 is processed using a beading machine (grooving machine) to form a recess in the battery can 11. Subsequently, an electrolytic solution is injected into the battery can 11 to impregnate the electrode wound body 20 with the electrolytic solution. Subsequently, the outer peripheral portion of the battery lid 14 and the outer peripheral portion of the safety cover 31 of the safety valve mechanism 30 are joined by welding, and the battery lid 14 and the safety valve mechanism 30 are housed inside the battery can 11 together with the gasket 15. The battery lid 14 may be manufactured by forming the above-described opening portions in a metal plate by a punching method or the like and then providing a protruding portion by a press molding method or the like as desired.

Next, as illustrated in FIG. 1, at the open end portion of the battery can 11, the outer peripheral portion of the battery lid 14 and the outer peripheral portion of the safety cover 31 are welded, and then the battery lid 14 and the safety valve mechanism 30 are crimped with the gasket 15 interposed therebetween to form the crimp structure 11R. Finally, the battery can 11 is closed with the battery lid 14 using a press machine, whereby the secondary battery is completed.

FIG. 7 is a block diagram illustrating a circuit configuration example in a case where the secondary battery according to the present disclosure is applied to a battery pack 300. The battery pack 300 includes an assembled battery 301, a switch unit 304 including a charge control switch 302a and a discharge control switch 303a, a current detection resistor 307, a temperature detection element 308, and a control unit 310. The control unit 310 can control each device, further perform charge and discharge control at the time of abnormal heat generation, and calculate and correct a remaining capacity of the battery pack 300. A positive electrode terminal 321 and a negative electrode terminal 322 of the battery pack 300 are connected to a charger or an electronic device, and are charged and discharged.

The assembled battery 301 has a plurality of secondary batteries 301a connected in series and/or in parallel. FIG. 7 illustrates an example in the case of connecting six secondary batteries 301a in two parallel and three series (2P3S).

A temperature detection unit 318 is connected to the temperature detection element 308 (for example, a thermistor), measures the temperature of the assembled battery 301 or the battery pack 300, and supplies the measured temperature to the control unit 310. A voltage detection unit 311 measures the voltages of the assembled battery 301 and each of the secondary batteries 301a included therein, performs A/D conversion on the measured voltages, and supplies the converted voltages to the control unit 310. A current measurement unit 313 measures a current using the current detection resistor 307, and supplies the measured current to the control unit 310.

A switch control unit 314 controls the charge control switch 302a and the discharge control switch 303a of the switch unit 304 based on the voltages and the current input from the voltage detection unit 311 and the current measurement unit 313. The switch control unit 314 transmits an OFF control signal to the switch unit 304 when the secondary battery 301a reaches a voltage equal to or higher than an overcharge detection voltage (for example, 4.20 V±0.05 V) or equal to or lower than an overdischarge detection voltage (2.4 V±0.1 V), thereby preventing overcharge or overdischarge.

After the charge control switch 302a or the discharge control switch 303a is turned off, charging or discharging can be performed only through a diode 302b or a diode 303b. As these charge/discharge switches, a semiconductor switch such as a MOSFET can be used. The switch unit 304 is provided on the positive side in FIG. 7 but may be provided on the negative side.

A memory 317 includes a RAM or a ROM, and stores and rewrites battery characteristic values calculated by the control unit 310, a full charge capacity, the remaining capacity, and the like.

The secondary battery according to the present disclosure described above is mounted on a device such as an electronic device, an electric transportation device, or a power storage device, and can be used for supplying electric power.

Examples of the electronic device include notebook personal computers, smartphones, tablet terminals, PDAS (personal digital assistants), mobile phones, wearable terminals, digital still cameras, electronic books, music players, game machines, hearing aids, power tools, televisions, lighting devices, toys, medical devices, and robots. In addition, electric transportation devices, power storage devices, power tools, and electric unmanned aerial vehicles to be described later can also be included in the electronic device in a broad sense.

Examples of the electric transportation device include electric vehicles (including hybrid vehicles), electric motorcycles, electric assisted bicycles, electric buses, electric carts, automatic guided vehicles (AGV), and railway vehicles. In addition, electric passenger aircrafts and electric unmanned aerial vehicles for transportation are also included. The secondary battery according to the present disclosure is used not only as a power source for driving these, but also as an auxiliary power supply, a power source for energy regeneration, and the like.

Examples of the power storage device include power storage modules for commercial use or household use, and power sources for electric power storage use for construction such as a house, a building, or an office, or for a power-generating facility.

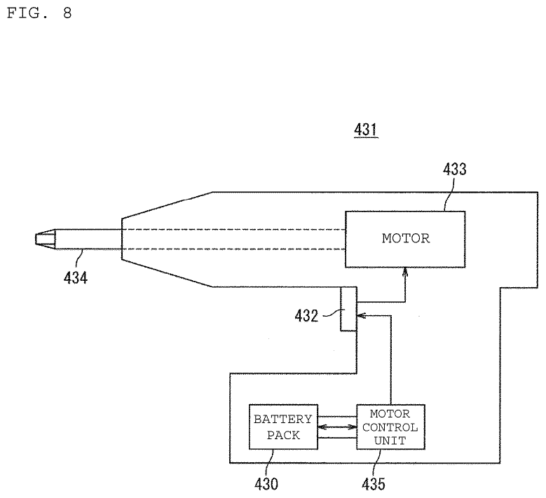

An example of an electric screwdriver as a power tool to which the present disclosure can be applied will be schematically described with reference to FIG. 8. An electric screwdriver 431 is provided with a motor 433 that transmits rotational power to a shaft 434 and a trigger switch 432 operated by a user. A battery pack 430 according to the present disclosure and a motor control unit 435 are housed in a lower housing of a handle of the electric screwdriver 431. The battery pack 430 is built in or detachably attached to the electric screwdriver 431.

Each of the battery pack 430 and the motor control unit 435 may be provided with a microcomputer (not illustrated) such that charge/discharge information of the battery pack 430 can be communicated with each other. The motor control unit 435 can control the operation of the motor 433, and cut off the power supply to the motor 433 at the time of abnormality such as overdischarge.

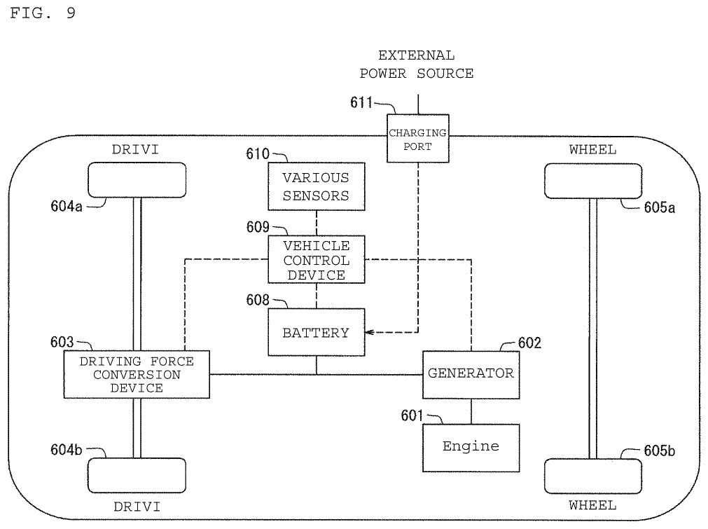

As an example in which the present disclosure is applied to a power storage system for an electric vehicle, FIG. 9 schematically illustrates a configuration example of a hybrid vehicle (HV) employing a series hybrid system. The series hybrid system is intended for a vehicle that travels with an electric power-driving force conversion device using electric power generated by a generator powered by an engine, or the electric power stored once in the battery.

An engine 601, a generator 602, an electric power-driving force conversion device 603 (DC motor or AC motor, hereinafter, it is simply referred to as the “motor 603”), a driving wheel 604a, a driving wheel 604b, a wheel 605a, a wheel 605b, a battery 608, a vehicle control device 609, various sensors 610, and a charging port 611 are mounted in a hybrid vehicle 600. As the battery 608, the battery pack 300 of the present disclosure or a power storage module on which a plurality of the secondary batteries of the present disclosure are mounted can be applied.

The motor 603 is operated by the electric power of the battery 608, and a rotational force of the motor 603 is transmitted to the driving wheels 604a and 604b. The battery 608 can store the electric power generated at the generator 602 by the rotational force produced by the engine 601. The various sensors 610 control an engine speed through the vehicle control device 609, or control an opening degree of a throttle valve (not illustrated).

When the hybrid vehicle 600 is decelerated by a brake mechanism (not illustrated), a resistance force during the deceleration is added as a rotational force to the motor 603, and regenerative electric power generated due to this rotational force is stored in the battery 608. The battery 608 can be charged by being connected to an external power source through the charging port 611 of the hybrid vehicle 600. Such an HV vehicle is referred to as a plug-in hybrid vehicle (PHV or PHEV).

Note that the secondary battery according to the present disclosure can also be applied to a downsized primary battery and used as a power source of a tire pressure monitoring system (TPMS) built in the wheels 604 and 605.

Although the series hybrid vehicle has been described above as an example, the present disclosure can be also applied to a parallel system in which an engine and a motor are used in combination or a hybrid vehicle in which a series system and a parallel system are combined. Furthermore, the present disclosure is also applicable to an electric vehicle (EV or BEV) and a fuel cell vehicle (FCV) that travels only by a drive motor without using an engine.

The present disclosure includes the following preferred aspects according to an embodiment.

<1> A cylindrical secondary battery including:
an electrode wound body having a structure in which a band-shaped positive electrode and a band-shaped negative electrode are stacked and wound with a separator interposed therebetween;
a battery can accommodating the electrode wound body with one end portion being open while the electrode wound body is accommodated; and
a battery lid provided at the one end portion of the battery can and having two or more opening portions,
wherein the two or more opening portions have a non-overlapping form during rotation that does not overlap the two or more opening portions before rotation when the two or more opening portions are rotated by more than 0° and less than 360° about an axis of a cylindrical shape of the secondary battery in top view, and
the battery lid has a cleavage impression at any one of joints between two adjacent opening portions out of the two or more opening portions.

<2> The cylindrical secondary battery according to <1>, wherein the two or more opening portions extend in a rotation direction about the axis.

<3> The cylindrical secondary battery according to <1> or <2>, wherein the two or more opening portions are arranged in a concentric region.

<4> The cylindrical secondary battery according to any one of <1> to <3>, wherein the two or more opening portions are arranged along a rotation direction about the axis.

<5> The cylindrical secondary battery according to any one of <1> to <4>, wherein the battery lid has a protruding portion in which a central region of the battery lid protrudes toward a counter electrode wound body side in a direction of the axis and an annular flange-shaped portion arranged around the protruding portion, and has the two or more opening portions on a side surface of the protruding portion.

<6> The cylindrical secondary battery according to any one of <1> to <5>, wherein the non-overlapping form during rotation is based on non-equal division of the opening portions, and the opening portions include two or more kinds of opening portions having opening portion dimensions different from each other.

<7> The cylindrical secondary battery according to any one of <1> to <6>, wherein the non-overlapping form during rotation is based on asymmetric shapes of the opening portions, and the opening portions include an opening portion having a one-end tapered shape tapered in a counterclockwise direction and an opening portion having a one-end tapered shape tapered in a clockwise direction.

<8> The cylindrical secondary battery according to any one of <1> to <7>, wherein the one joint in which the cleavage impression is arranged is a joint in which a load caused by ejection is maximized when gas is ejected from the inside of the cylindrical secondary battery.

<9> The cylindrical secondary battery according to any one of <1> to <8>, wherein an opening ratio of the two opening portions is 5.0% or more and 12.0% or less with respect to a battery radial area.

<10> The cylindrical secondary battery according to any one of <1> to <9>, wherein the battery lid includes a metal material selected from the group consisting of iron, stainless steel, aluminum, and alloys thereof.

<11> An electronic device including the cylindrical secondary battery according to any one of <1> to <10>.

<12> A power tool including the cylindrical secondary battery according to any one of <1> to <10>.

### EXAMPLES

### Examples 1 to 8 and Comparative Examples 1 to 6

A cylindrical secondary battery was produced according to the “Method of Manufacturing Cylindrical Secondary Battery” described above using a common material except that a battery lid having a configuration and a structure shown in Table 1 was used in each of Examples and Comparative Examples.

In each of Examples and Comparative Examples, the detailed dimension, shape, and arrangement of opening portions in the battery lid are as follows. The radius r of the battery lid 14 was 8.1 mm, and the thickness t2 of the protruding portion 141 of the battery lid 14 was 0.4 mm.

### Example 1

The battery lid 14 illustrated in FIG. 2 was used.

Opening angle α1 in relation to opening portion dimension x1 of opening portion 200a1=90° Distance r1 from axis (center) of opening portion 200a1=0.5×r

Radial width w1 of opening portion 200a1=0.133×r Opening angle x2 in relation to opening portion dimension x1 of opening portion 200b1=90°

Distance r1 (not illustrated) from axis (center) of opening portion 200b1=0.5×r

Radial width w1 (not illustrated) of opening portion 200b1=0.133×r

Opening angle x3 in relation to opening portion dimension x2 of opening portion 200c1=40°

Distance r1 (not illustrated) from axis (center) of opening portion 200c1=0.5×r

Radial width w1 (not illustrated) of opening portion 200c1=0.133×r

Opening angle x4 in relation to opening portion dimension x2 of opening portion 200d1=40°

Distance r1 (not illustrated) from axis (center) of opening portion 200d1=0.5×r

Radial width w1 (not illustrated) of opening portion 200d1=0.133×r

Thickness t1 of cleavage impression 145=0.2×t2 Example 2

The battery lid 14 illustrated in FIG. 3 was used.

Opening angle β1 in relation to opening portion dimension x3 of opening portion 200a2=60°

Distance r1 from axis (center) of opening portion 200a2=0.5×r

Radial width w1 of opening portion 200a2=0.133×r Opening angle 2 in relation to opening portion dimension x3 of opening portion 200b2=60°

Distance r1 (not illustrated) from axis (center) of opening portion 200b2=0.5×r

Radial width w1 (not illustrated) of opening portion 200b2=0.133×r

Opening angle β3 in relation to opening portion dimension x3 of opening portion 200c2=60°

Distance r1 (not illustrated) from axis (center) of opening portion 200c2=0.5×r

Radial width w1 (not illustrated) of opening portion 200c2=0.133×r

Opening angle 4 in relation to opening portion dimension x3 of opening portion 200d2=60° Distance r1 (not illustrated) from axis (center) of opening portion 200d2=0.5×r

Radial width w1 (not illustrated) of opening portion 200d2 0.133×r

Thickness t1 of cleavage impression 145=0.2×t2 Example 3

The same battery lid as in Example 1 was used except that the dimension W1=0.133×r was changed to the dimension W1=0.148×r.

### Example 4

The same battery lid as in Example 1 was used except that the dimension W1=0.133×r was changed to the dimension W1=0.160×r.

### Example 5

The same battery lid as in Example 2 was used except that the dimension W1=0.133×r was changed to the dimension W1=0.148×r.

### Example 6

The same battery lid as in Example 2 was used except that the dimension W1=0.133×r was changed to the dimension W1=0.160×r.

### Example 7

The same battery lid as in Example 1 was used except that a constituent material was changed to stainless steel.

### Example 8

The same battery lid as in Example 1 was used except that a constituent material was changed to aluminum.

### Comparative Example 1

A battery lid illustrated in FIG. 10 was used. In FIG. 10, opening portions 800a to 800c have the same dimension and the same shape as each other, and are arranged at equal intervals in the circumferential direction about an axis of a cylindrical shape of a secondary battery.

Opening angles x11 in relation to opening portion dimensions of opening portions 800a to 800c=80°

Distances r11 from axes (centers) of opening portions 800a to 800c=0.5×r

Radial widths w11 of opening portions 800a to 800c=0.133×r

### Comparative Example 2

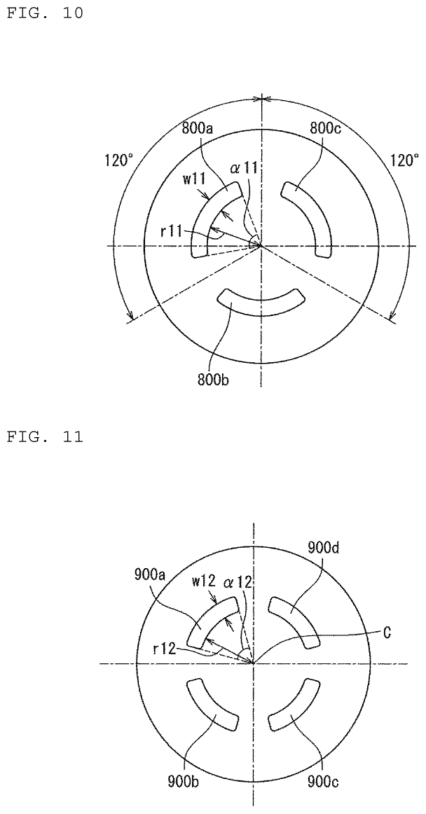

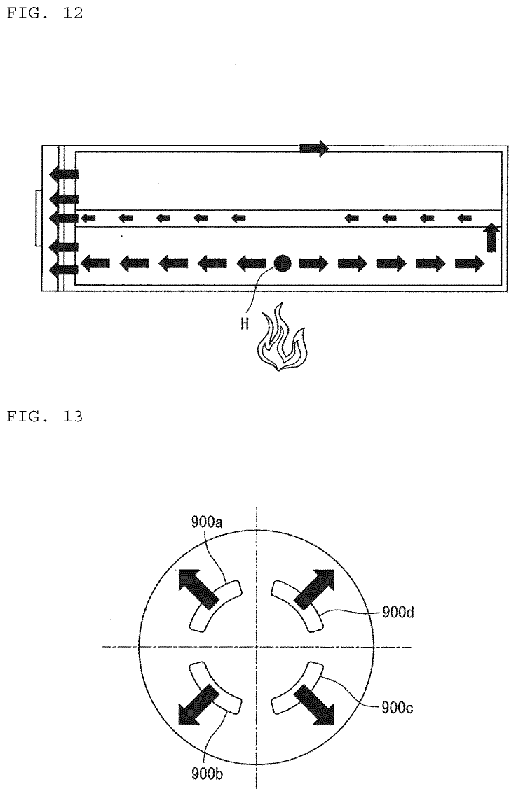

A battery lid illustrated in FIG. 11 was used. In FIG. 11, opening portions 900a to 900d have the same dimension and the same shape as each other, and are arranged at equal intervals in the circumferential direction about an axis of a cylindrical shape of a secondary battery.

Opening angles x12 in relation to opening portion dimensions of opening portions 900a to 900d=60° Distances r12 from axes (centers) of opening portions 900a to 900d=0.5×r

Radial widths w12 of opening portions 900a to 900d=0.133×r

### Comparative Example 3

The same battery lid as in Comparative Example 1 was used except that a cleavage impression having a thickness of 0.2×t2 was provided at a joint between the opening portion 800a and the opening portion 800b.

### Comparative Example 4

The same battery lid as in Comparative Example 2 was used except that a cleavage impression having a thickness of 0.2×t2 was provided at a joint between the opening portion 900a and the opening portion 900b.

### Comparative Example 5

The same battery lid as in Example 1 was used except that no cleavage impression was provided.

### Comparative Example 6

The same battery lid as in Example 2 was used except that no cleavage impression was provided.

[Evaluation] The above Examples and Comparative Examples were subjected to a combustion test and a drop test.

### Combustion Test:

The combustion test is based on the UL 1642 projectile test. The combustion test was a test for evaluating a pop-out of a battery like a projectile, and a battery in which the pop-out like the projectile occurred was evaluated as a failure, a case where a pass rate in the combustion test was 90% or more was evaluated as “not problematic in practical use (Δ)”, and a case where the pass rate in the combustion test was less than 90% was evaluated as “problematic in practical use (x)”. In particular, a case where the pass rate was 92% or more was evaluated as “good (◯)”, and a case where the pass rate was 95% or more was evaluated as “excellent (⊚)”. The number of tests is 100.

### Drop Test:

When the battery having a battery voltage of 4.4 V was dropped 100 times from a height of 10 m, a condition that an electrolytic solution in the battery does not leak to the outside at all was defined as a pass condition. The number of tests is 100. As a criteria for determination, a case where the pass rate was 80% or more was evaluated as “not problematic in practical use (Δ)”, and a case where the pass rate was less than 80% was evaluated as “problematic in practical use (x)”. In particular, a case where the pass rate was 90% or more was evaluated as “good (◯)”, and a case where the pass rate was 95% or more was evaluated as “excellent (⊚)”.

TABLE 1

| | Configuration | | | |
|---|---|---|---|---|
| | Battery lid (top cover) | | | |
| | | | Opening | |
| | | | ratio on | |
| | | Cleavage | battery | |
| | Shape of gas release | impression at | section | |
| | opening portion | joint | basis | Material |
| Example 1 | FIG. 2: Non-equal | Present | 8.8% | Iron |
| | division | | | |
| Example 2 | FIG. 3: Asymmetric shapes | Present | 8.0% | Iron |
| Example 3 | FIG. 2: Non-equal | Present | 10.0% | Iron |
| | division | | | |
| Example 4 | FIG. 2: Non-equal | Present | 11.0% | Iron |
| | division | | | |
| Example 5 | FIG. 3: Asymmetric shapes | Present | 10.0% | Iron |
| Example 6 | FIG. 3: Asymmetric shapes | Present | 11.0% | Iron |
| Example 7 | FIG. 2: Non-equal | Present | 8.8% | Stainless |
| | division | | | |
| Example 8 | FIG. 2: Non-equal | Present | 8.8% | Aluminum |
| | division | | | |
| Comparative | FIG. 10: 3 holes, Equal | Absent | 7.2% | Iron |
| Example 1 | division of opening holes | | | |
| Comparative | FIG. 11: 4 holes, Equal | Absent | 7.3% | Stainless |
| Example 2 | division of opening holes | | | |
| Comparative | FIG. 10: 3 holes, Equal | Present | 7.2% | Iron |
| Example 3 | division of opening holes | | | |
| Comparative | FIG. 11: 4 holes, Equal | Present | 7.3% | Stainless |
| Example 4 | division of opening holes | | | |
| Comparative | FIG. 2 (without joint): | Absent | 8.8% | Iron |
| Example 5 | Non-equal division | | | |
| Comparative | FIG. 3 (without joint): | Absent | 8.0% | Iron |
| Example 6 | Asymmetric shapes | | | |

| | Effects | |
|---|---|---|
| | Combustion test pass rate | Drop test pass rate |
| Example 1 | 95%⊚ | 98%⊚ |
| Example 2 | 96%⊚ | 95%⊚ |
| Example 3 | 99%⊚ | 95%⊚ |
| Example 4 | 99%⊚ | 85%Δ |
| Example 5 | 98%⊚ | 90%◯ |
| Example 6 | 98%⊚ | 80%Δ |
| Example 7 | 95%⊚ | 99%⊚ |
| Example 8 | 99%⊚ | 91%◯ |
| Comparative | 80%X | — |
| Example 1 | | |
| Comparative | 85%X | — |
| Example 2 | | |
| Comparative | 83%X | — |
| Example 3 | | |
| Comparative | 87%X | — |
| Example 4 | | |
| Comparative | 88%X | — |
| Example 5 | | |
| Comparative | 89%X | — |
| Example 6 | | |

Comparison between Example 1 to 8 and Comparative Example 1 to 6 has revealed the following matters.

When the battery lid was provided with gas release opening portions in a non-overlapping form during rotation (non-equal division or asymmetric shapes) and added with the cleavage impression, the pop-out of the battery like the projectile at the time of battery abnormality was prevented, thereby improving the pass rate of the combustion test and enhancing the safety.

Comparison of Examples 1 to 3, 5, and 7 with Examples 4, 6, and 8 has revealed the following matters.

When nan opening ratio of the opening portions was set to 8.0% or more and 10.0% or less and iron or stainless steel was used as a constituent material of the battery lid, the safety was enhanced while maintaining the strength characteristic.

The secondary battery according to the present disclosure may be used in various fields in which power storage is assumed. Although it is merely an example, the secondary battery according to the present disclosure, in particular, the nonaqueous electrolyte secondary battery, may be used in the fields of electricity, information, and communication in which mobile devices and the like are used (for example, mobile equipment fields such as mobile phones, smart phones, smartwatches, notebook computers, digital cameras, activity meters, arm computers, and electronic papers), home and small industrial applications (for example, the fields of power tools, golf carts, and home, nursing, and industrial robots), large industrial applications (for example, fields of forklift, elevator, and harbor crane), transportation system fields (for example, the field of hybrid vehicles, electric vehicles, buses, trains, power-assisted bicycles, and electric two-wheeled vehicles), power system applications (for example, fields of various kinds of power generation, road conditioners, smart grids, and household power storage systems), medical applications (medical equipment fields such as hearing aid earbuds), pharmaceutical applications (fields such as dosage management systems), IoT fields, space and deep sea applications (for example, the fields of a space probe and a research submersible), and the like.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A cylindrical secondary battery comprising:
an electrode wound body having a structure in which a band-shaped positive electrode and a band-shaped negative electrode are stacked and wound with a separator interposed therebetween;
a battery can accommodating the electrode wound body with one end portion being open while the electrode wound body is accommodated; and
a battery lid provided at the one end portion of the battery can and having two or more opening portions,
wherein the two or more opening portions have a non-overlapping form during rotation that does not overlap the two or more opening portions before rotation when the two or more opening portions are rotated by more than 0° and less than 360° about an axis of a cylindrical shape of the secondary battery in top view, and
the battery lid has a cleavage impression at any one of joints between two adjacent opening portions out of the two or more opening portions.

2. The cylindrical secondary battery according to claim 1, wherein the two or more opening portions extend in a rotation direction about the axis.

3. The cylindrical secondary battery according to claim 1, wherein the two or more opening portions are arranged in a concentric region.

4. The cylindrical secondary battery according to claim 1, wherein the two or more opening portions are arranged along a rotation direction about the axis.

5. The cylindrical secondary battery according to claim 1, wherein the battery lid has a protruding portion in which a central region of the battery lid protrudes toward a counter electrode wound body side in a direction of the axis and an annular flange-shaped portion arranged around the protruding portion, and has the two or more opening portions on a side surface of the protruding portion.

6. The cylindrical secondary battery according to claim 1, wherein the non-overlapping form during rotation is based on non-equal division of the opening portions, and the opening portions include two or more kinds of opening portions having opening portion dimensions different from each other.

7. The cylindrical secondary battery according to claim 1, wherein the non-overlapping form during rotation is based on asymmetric shapes of the opening portions, and the opening portions include an opening portion having a one-end tapered shape tapered in a counterclockwise direction and an opening portion having a one-end tapered shape tapered in a clockwise direction.

8. The cylindrical secondary battery according to claim 1, wherein the one joint in which the cleavage impression is arranged is a joint in which a load caused by ejection is maximized when gas is ejected from an inside of the cylindrical secondary battery.

9. The cylindrical secondary battery according to claim 1, wherein an opening ratio of the two opening portions is 5.0% or more and 12.0% or less with respect to a battery radial area.

10. The cylindrical secondary battery according to claim 1, wherein the battery lid includes a metal material selected from the group consisting of iron, stainless steel, aluminum, and alloys thereof.

11. An electronic device comprising the cylindrical secondary battery according to claim 1.

12. A power tool comprising the cylindrical secondary battery according to claim 1.
